(19) United States
(12) Patent Application Publication
(10) Pub. No.: US 2016/0047526 A1
(43) Pub. Date: Feb. 18, 2016

(54) KNOCKDOWN OPTICAL COMPONENT STRUCTURE

(71) Applicant: EDISON OPTO CORPORATION, NEW TAIPEI CITY (TW)

(72) Inventors: CHIEN JUNG WU, NEW TAIPEI CITY (TW); CHIEN YU SHEN, NEW TAIPEI CITY (TW)

(21) Appl. No.: 14/556,463

(22) Filed: Dec. 1, 2014

(30) Foreign Application Priority Data
Aug. 15, 2014 (TW) 103128198

(51) Int. Cl. F21V 5/04

(52) U.S. Cl. CPC F21V 5/045

(57) ABSTRACT

A knockdown optical component structure is disclosed. According to the light source wattage, size or area, an operator can change the optical lens assembling mode and optical emission effect to modify the light source illumination or arrangement form. The knockdown optical component structure includes a light guide substrate body and at least one light guide body assembled therewith. A connection section is disposed on a circumferential section of the light guide substrate body. A predetermined section of the light guide body is formed with a perforation (or a depression). An assembling section is formed on the perforation or the depression. The connection section is rotatably connected with the assembling section, whereby the light guide substrate body is detachably received in the perforation or the depression of the light guide body to form an optical component assembly.

### BACKGROUND OF THE INVENTION

1. Field of the Invention

The present invention relates generally to a knockdown optical component structure, and more particularly to an illumination system employing multiple light guide bodies, which are detachably assembled to provide different optical emission effects.

2. Description of the Related Art

In a conventional optical component structure, an optical lens or structure such as Fresnel optical lens, total internal reflection (TIR) optical structure, refraction-reflection total internal reflection (RXI) short-focus optical structure or the like optical lens is applied to a light source (such as an LED chip). The light beam emitted from the light source passes through the optical lenses to be emitted therefrom. In general, such kind of optical lenses or light guide device is applicable to an illuminator, an indicator, a projector, a flashlight or other lighting devices.

A conventional technique provides an optical lens with multiple zoom curved faces on the surface for varying the light emission effect. For example, prior arts disclose a zoom multilevel lens for illumination and a knockdown lens structure. Another prior art discloses an optical lens in which the fixing board or the emission section is formed with multiple perforations for respectively correspondingly assembling with multiple bowl-shaped light guides and light source.

In the application of the conventional optical lens to illumination or light emission device, it is necessary to manufacture different sizes of optical lenses according to the wattages and volumes of the light sources for providing the designed light emission or illumination effect. This will lead to increase of the manufacturing cost of the mold and the optical lenses. Moreover, the variability and application degree of freedom of the cooperation between the optical lenses and the light sources are lowered. This is not what we expect.

It is therefore tried by the applicant to provide a knockdown optical component structure in which the optical lenses and the assembling structures of the relevant connection components are redesigned to change the use form and widen the application range of the optical component structure. The knockdown optical component structure is different from and advantageous over the conventional optical component structure. For example, with respect to the structural design and optical emission effect, the present invention overcomes the problem of the conventional optical component structure that it is necessary to manufacture different sizes of optical lenses according to different light sources so that the manufacturing cost is increased and the variability and application degree of freedom of the cooperation between the optical lenses and the light source are lowered.

### SUMMARY OF THE INVENTION

It is therefore a primary object of the present invention to provide a knockdown optical component structure. According to the light source wattage, size or area, an operator can change the optical lens assembling mode and optical emission effect to modify the light source illumination or the arrangement form. The knockdown optical component structure includes a light guide substrate body and at least one light guide body assembled therewith. A connection section is disposed on a circumferential section of the light guide substrate body. A predetermined section of the light guide body is formed with a perforation (or a depression). An assembling section is formed on the perforation or the depression. The connection section is rotatably connected with the assembling section, whereby the light guide substrate body is detachably received in the perforation or the depression of the light guide body to form an optical component assembly. The knockdown optical component structure overcomes the problem of the conventional optical component structure that it is necessary to troublesomely manufacture different sizes of optical lenses according to different light sources so that the optical variability is lowered.

In the above knockdown optical component structure, the light guide substrate body and the light guide body are defined with a central reference axis. Each of the light guide substrate body and the light guide body has a light guide face and an emission face. The light guide face is a plane face. The emission face is a curved face or an inclined face. The heights of the curved or inclined emission faces of the light guide substrate body and the light guide body are progressively decreased or increased from the central reference axis to the circumferential sections.

In the above knockdown optical component structure, the light guide body includes a first light guide body, a second light guide body, a third light guide boy and/or a fourth light guide body. The circumferential section of each of the first, second, third and fourth light guide bodies is formed with a connection section. A perforation (or a depression) is formed at each of the first, second, third and fourth light guide bodies. An assembling section is formed on the perforation (or the depression). The connection section of each light guide body is rotatably connected with the assembling section, whereby the first light guide body is detachably received in the perforation (or the depression) of the second light guide body, the second light guide body is detachably received in the perforation (or the depression) of the third light guide body and the third light guide body is detachably received in the perforation (or the depression) of the fourth light guide body to forma complete optical component assembly.

The present invention can be best understood through the following description and accompanying drawings, wherein:

### BRIEF DESCRIPTION OF THE DRAWINGS

FIG. 1 is a perspective assembled view of the present invention, showing that the light guide substrate body is assembled with multiple light guide bodies;

FIG. 2 is a perspective exploded view according to FIG. 1, showing that the light guide substrate body is assembled with multiple light guide bodies;

FIG. 3 is a sectional view according to FIG. 1, showing that the light guide substrate body is assembled with multiple light guide bodies;

FIG. 4 is a sectional view of an embodiment of the present invention, showing that the connection section of the light guide substrate body is a threaded structure and the assembling section of the light guide body is rotatably connected with the connection section;

FIG. 5 is a sectional view of another embodiment of the present invention, showing that the connection section of the light guide substrate body is a slope and the assembling section of the light guide body is rotatably connected with the connection section;

FIG. 6 is a sectional view of still another embodiment of the present invention, showing that the connection section of the light guide substrate body is an insertion section and the assembling section of the light guide body is inserted with the connection section;

FIG. 7 is a sectional view of still another embodiment of the present invention, showing that the connection section of the light guide substrate body is an insertion groove and the assembling section of the light guide body is inserted in the connection section;

FIG. 8 is a sectional view of the assembly of the present invention and a light source, showing the light path through the light guide substrate body and the light guide body;

FIG. 9 is an illumination distribution diagram according to FIG. 8;

FIG. 10 is a sectional view of the assembly of the present invention and a light source, showing the light path through the light guide substrate body, the first light guide body, the second light guide body, the third light guide body and the fourth light guide body;

FIG. 11 is an illumination distribution diagram according to FIG. 10;

FIG. 12 is a sectional view of a modified embodiment of the present invention, showing that the light guide face of the light guide substrate body is a curved face, while the light guide faces of the first light guide body, the second light guide body, the third light guide body and the fourth light guide body are inclined face or curved faces; and

FIG. 13 is a perspective exploded view of a modified embodiment of the present invention, showing that the light guide substrate body is assembled with multiple light guide bodies.

### DETAILED DESCRIPTION OF THE PREFERRED EMBODIMENTS

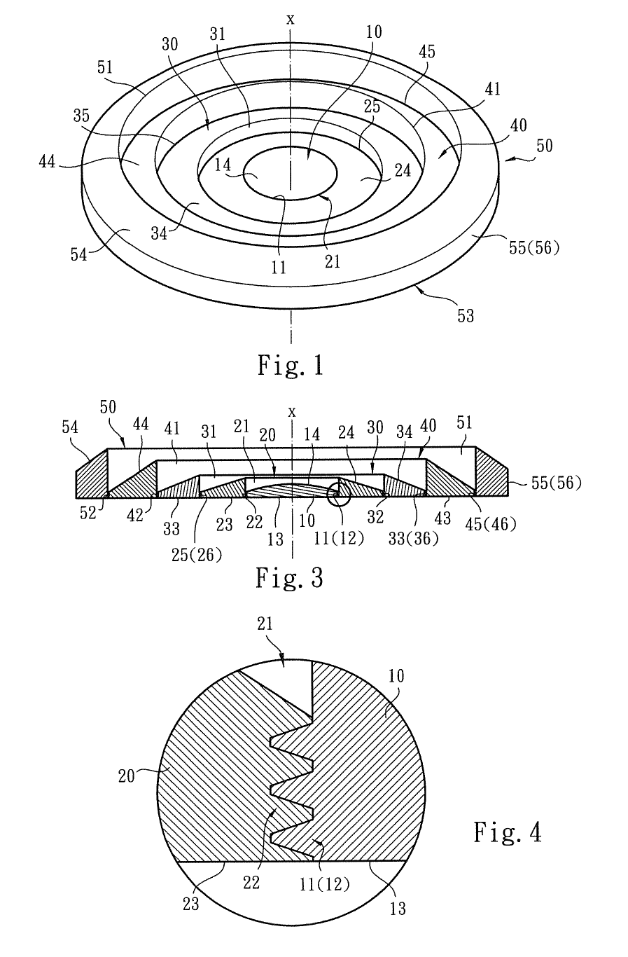

Please refer to FIGS. 1, 2 and 3. In a preferred embodiment, the knockdown optical component structure of the present invention is a Fresnel optical lens or optical component for illustration purposes. The optical component includes a light guide substrate body 10 and at least one light guide body 20 assembled therewith. The light guide substrate body 10 and the light guide body 20 are made of transparent material in a geometrical form and defined with a central reference axis χ. In this embodiment, the light guide substrate body 10 is a circular board body formed with a circumferential section 11 and a connection section 12 disposed on the circumferential section 11. The light guide substrate body 10 includes a light guide face 13 and an emission face 14 corresponding to the light guide face 13. The circumferential section 11 is positioned in a circumferential position of the light guide face 13 and the emission face 14.

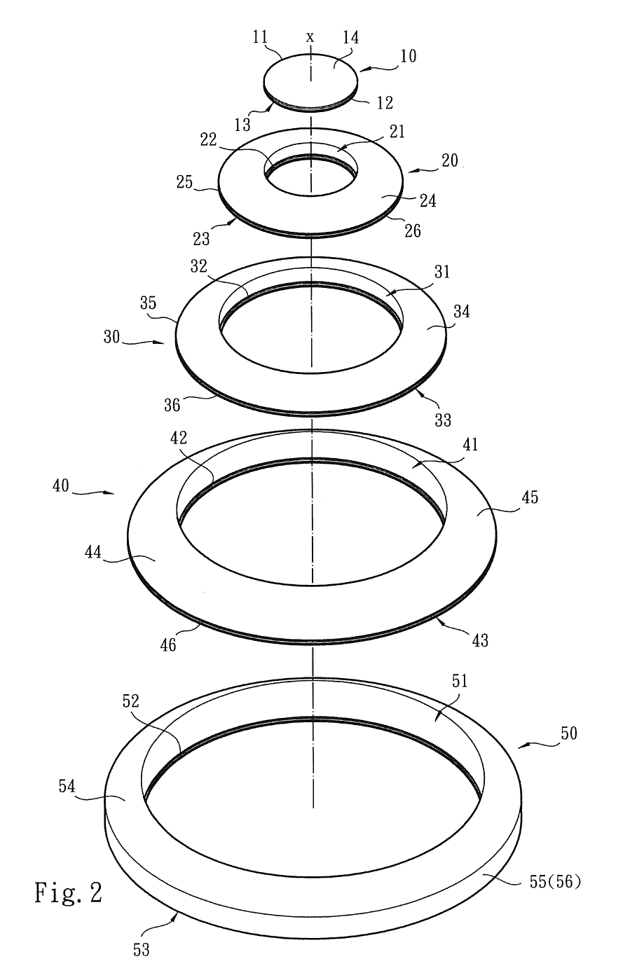

As shown in FIGS. 2 and 3, the light guide face 13 is a plane face, while the emission face 14 is a curved face. The height of the curved emission face 14 is progressively decreased or increased from a section near the central reference axis χ to the circumferential section 11.

As in the drawings, a predetermined section or a central section of the light guide body 20 is formed with a perforation 21 and an assembling section 22 formed on the perforation 21 (lower section). Accordingly, the light guide body 20 has the form of a ring-shaped board body. The connection section 12 of the light guide substrate body 10 is rotatably connected with the assembling section 22, whereby the light guide substrate body 10 is detachably received in the perforation 21 of the light guide body 20 to form a complete optical component assembly. To speak more specifically, the connection section 12 of the light guide substrate body 10 and the assembling section 22 of the light guide body 20 are threaded structures, whereby the light guide substrate body 10 is detachably locked in the perforation 21 of the light guide body 20 as shown in FIGS. 3 and 4.

In this embodiment, the light guide body 20 also has a light face 23, an emission face 24 corresponding to the light guide face 23 and a circumferential section 25 positioned in a circumferential position of the light guide face 23 and the emission face 24. The light guide face 23 is a plane face, while the emission face 24 is a curved or inclined face. The height of the curved or inclined emission face 24 of the light guide body 20 is progressively decreased or increased from a section near the central reference axis χ to the circumferential section 25.

In a preferred embodiment, the light guide body 20 includes a first light guide body, a second light guide body 30, a third light guide body 40 and/or a fourth light guide body 50. In this embodiment, the light guide body 20 is defined as the first light guide body 20. The circumferential section 25 of the first light guide body 20 is formed with a connection section 26 having a threaded structure for rotatably connecting with the second light guide body 30. The second light guide body 30 is rotatably connected with the third light guide body 40. The third light guide body 40 is rotatably connected with the fourth light guide body 50.

To speak more specifically, the second, third and fourth light guide bodies 30, 40, 50 have the form of a ring-shaped board body similar to the light guide body 20 or the first light guide body 20. A predetermined section or a central section of each of the second, third and fourth light guide bodes 30, 40, 50 is formed with a perforation 31, 41, 51 and an assembling section 32, 42, 52 is formed on the perforation 31, 41, 51 (lower section). Each of the second, third and fourth light guide bodes 30, 40, 50 has a light face 33, 43, 53, an emission face 34, 44, 54 corresponding to the light guide face 33, 43, 53 and a circumferential section 35, 45, 55 positioned in a circumferential position of the light guide face 33, 43, 53 and the emission face 34, 44, 54. The circumferential section 35, 45, 55 of each of the second, third and fourth light guide bodes 30, 40, 50 is formed with a connection section 36, 46 and/or 56.

In this embodiment, the assembling sections 32, 42, 52 and the connection section 36, 46 and/or 56 are threaded structures.

Accordingly, the connection section 26 of the light guide body 20 or the first light guide body is rotatably connected with the assembling section 32 of the second light guide body, whereby the first light guide body 20 is detachably received in the perforation 31 of the second light guide body 30. The connection section 36 of the second light guide body 30 is rotatably connected with the assembling section 42 of the third light guide body 40, whereby the second light guide body 30 is detachably received in the perforation 41 of the third light guide body 40. The connection section 46 of the third light guide body 40 is rotatably connected with the assembling section 52 of the fourth light guide body 50, whereby the third light guide body 40 is detachably received in the perforation 51 of the fourth light guide body 50 to form a complete optical component assembly as shown in FIG. 3.

It should be noted that the light guide faces 33, 43, 53 of the second, third and fourth light guide bodies 30, 40, 50 are plane faces, while the emission faces 34, 44, 54 are curved or inclined faces. The height of the curved or inclined emission faces 34, 44, 54 is progressively decreased or increased from a sect ion near the central reference axis χ to the circumferential sections 35, 45, 55.

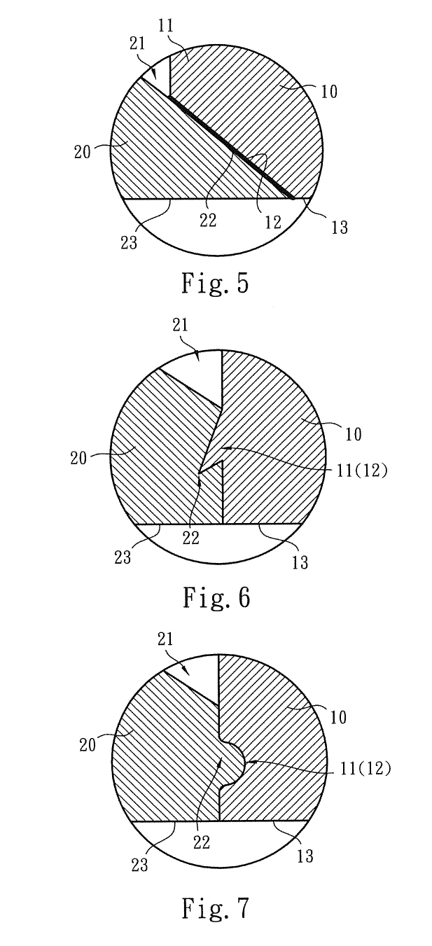

FIG. 5 shows a modified embodiment of the present invention. With the light guide substrate body 10 and the light guide body 20 (or the first light guide body 20) taken as an example, the connection section 12 of the light guide substrate body 10 is a slope structure downward inclined from the circumferential section 11 toward the central section (or the central reference axis χ). The assembling section 22 of the light guide body 20 is a bearing slope structure corresponding to the connection section 12. The bearing slope structure is downward inclined from the perforation 21 toward the central section (or the central reference axis χ). Therefore, the assembling section 22 of the light guide body 20 bears and supports the connection section 12 of the light guide substrate body 10 to assemble the light guide substrate body 10 in the perforation 21 of the light guide body 20.

It should be noted that the connection sections 26, 36, 46 of the first, second and third light guide bodies 20, 30, 40 can be also slope structures respectively downward inclined from the circumferential sections 25, 35, 45 of the first, second and third light guide bodies 20, 30, 40 toward the central reference axis χ. The assembling sections 32, 42, 52 of the second, third and fourth light guide bodies 30, 40, 50 are bearing slope structures corresponding to the connection sections 26, 36, 46. The bearing slope structures are respectively downward inclined from the perforations 31, 41, 51 of the second, third and fourth light guide bodies 30, 40, 50 toward the central reference axis χ.

FIG. 6 shows another modified embodiment of the present invention. The connection section 12 of the light guide substrate body 10 is an insertion section or a protrusion structure. The assembling section 22 of the light guide body 20 is an insertion groove or recessed groove structure corresponding to the connection section 12. The connection section 12 of the light guide substrate body 10 can be inserted into the assembling section 22 of the light guide body 20 to assemble the light guide substrate body 10 in the perforation 21 of the light guide body 20.

FIG. 7 shows still another modified embodiment of the present invention. The connection section 12 of the light guide substrate body 10 is an insertion groove or recessed groove structure. The assembling section 22 of the light guide body 20 is an insertion section or a protrusion structure corresponding to the connection section 12. The connection section 12 of the light guide substrate body 10 can be inserted with the assembling section 22 of the light guide body 20 to assemble the light guide substrate body 10 in the perforation 21 of the light guide body 20.

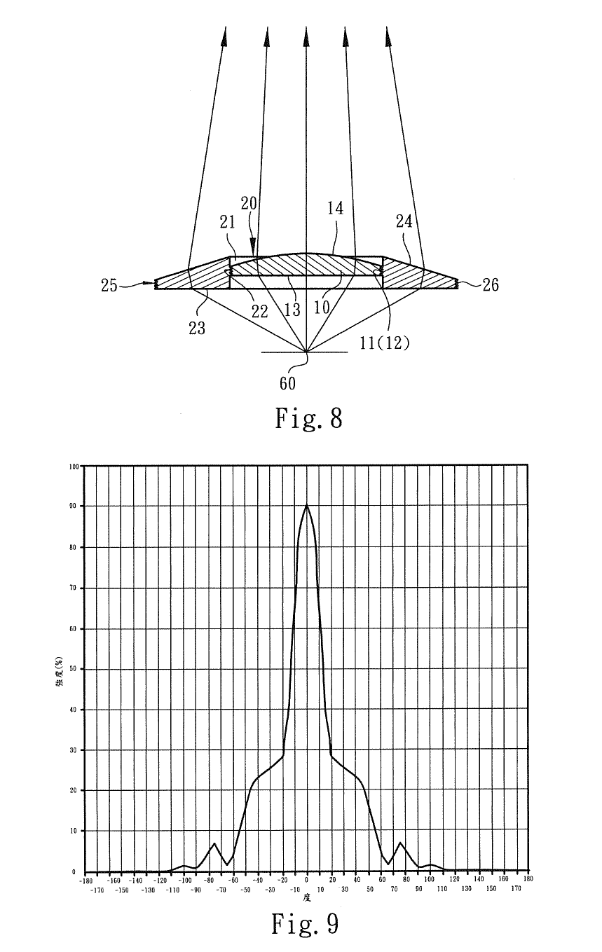

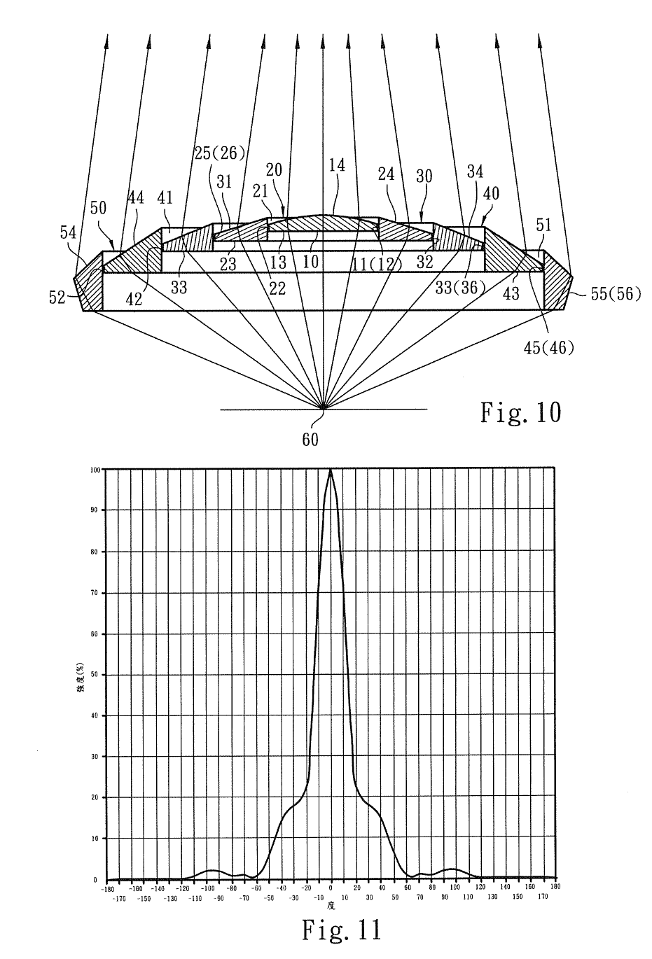

Please now refer to FIG. 8, which shows the light path of the assembly of the light guide substrate body 10, the light guide body 20 and a light source 60. The assembling section 22 of the light guide body 20 is formed near a middle section or upper section of the perforation 21. The optical component assembly of the light guide substrate body 10 and the light guide body 20 is positioned in the light path of the light source 60. The light is emitted from the light source 60 to the light guide faces 13, 23 of the light guide substrate body 10 and the light guide body 20 to go into the light guide substrate body 10 and the light guide body 20 and then is emitted from the emission faces 14, 24.

As shown in the drawings, the light beam emitted from the emission faces 14, 24 is converged to the central reference axis χ. Therefore, the illumination distribution diagram of FIG. 9 shows that the light beam angle ranges from 15° to 30° (such as about 27°).

Please now refer to FIG. 10, which shows the light path of the assembly of the light guide substrate body 10, the light guide body (or the first light guide body) 20, the second light guide body 30, the third light guide body 40, the fourth light guide body 50 and the light source 60. The assembling sections 22, 32, 42, 52 of the light guide body (or the first light guide body) 20, the second light guide body 30, the third light guide body 40 and the fourth light guide body 50 are formed near middle sections or upper sections of the perforations 21, 31, 41, 51. The optical component assembly of the light guide substrate body 10, the light guide body 20, the second light guide body 30, the third light guide body 40 and the fourth light guide body 50 is positioned in the light path of the light source 60. The light is emitted from the light source 60 to the light guide faces 13, 23, 33, 43, 53 of the light guide substrate body 10, the light guide body 20, the second light guide body 30, the third light guide body 40 and the fourth light guide body 50 to go into the light guide substrate body 10, the light guide body 20, the second light guide body 30, the third light guide body 40 and the fourth light guide body 50 and then is emitted from the emission faces 14, 24, 34, 44, 54.

As shown in the drawings, the light beam emitted from the emission faces 14, 24, 34, 44, 54 is converged to the central reference axis χ. Therefore, the illumination distribution diagram of FIG. 11 shows that the light beam angle ranges from 15° to 30° (such as about 25°).

It should be noted that the comparison between FIGS. 8 and 9 and FIGS. 10 and 11 reveals that the optical component assembly of the light guide substrate body 10 and the light guide body 20 requires smaller optical space (the height of the lens is about 8 mm). Therefore, this provides more versatile design of the assembly and higher lumen. In comparison with the optical system composed of the light guide substrate body 10 and the light guide body (or the first light guide body) 20, the optical component assembly of the light guide substrate body 10, the light guide body (or the first light guide body) 20, the second light guide body 30, the third light guide body 40 and the fourth light guide body 50 provides higher illumination. The optical space means the distance between the lens and the light source.

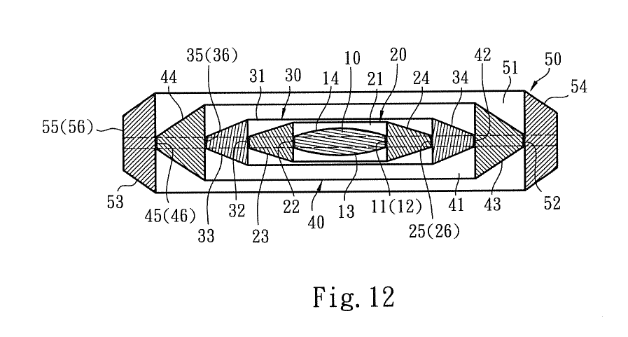

Please refer to FIG. 12, which shows a modified embodiment of the light guide faces 13, 23, 33, 43, 53 of the light guide substrate body 10, the light guide body (or the first light guide body) 20, the second light guide body 30, the third light guide body 40 and the fourth light guide body 50. In this embodiment, the light guide face 13 of the light guide substrate body is a curved face, while the light guide faces 23, 33, 43, 53 of the light guide body (or the first light guide body) 20, the second light guide body 30, the third light guide body 40 and the fourth light guide body 50 are inclined face or curved faces.

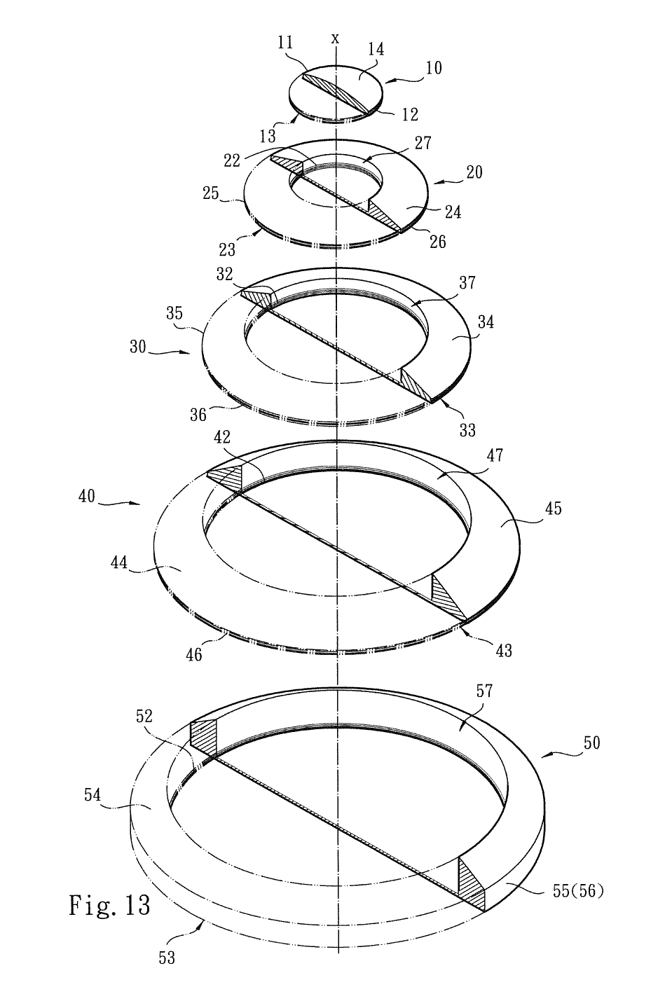

Please now refer to FIG. 13, which shows a modified embodiment of the structures of the light guide body (or the first light guide body) 20, the second light guide body 30, the third light guide body 40 and the fourth light guide body 50. A predetermined section or a central section of each of the light guide body (or the first light guide body) 20, the second light guide body 30, the third light guide body 40 and the fourth light guide body 50 is formed with a depression (non-perforation) 27, 37, 47, 57. The assembling sections 22, 32, 42, 52 are formed on the depressions 27, 37, 47, 57. Therefore, the light guide substrate body 10 is detachably received in the depression 27 of the first light guide body 20. The first light guide body 20 is detachably received in the depression 37 of the second light guide body 30. The second light guide body 30 is detachably received in the depression 47 of the third light guide body 40. The third light guide body 40 is detachably received in the depression 57 of the fourth light guide body 50 to form a complete optical component assembly.

In comparison with the conventional optical component structure, the knockdown optical component structure of the present invention has the following advantages in structural design and optical emission effect:
1. The optical device or relevant cooperative structure composed of the light guide substrate body 10 and the light guide body 20 is redesigned. For example, the light guide face 13 of the light guide substrate body 10 is a plane face or curved face. The emission face 14 of the light guide substrate body and the emission face 24 (or 34, 44, 54) of the light guide body is a curved face. The height of the curved emission face is progressively decreased or increased from a section near the central reference axis χ to the circumferential section 11, 25 (or 35, 45, 55). The circumferential section 11 of the light guide substrate body 10 is formed with the connection section 12 in adaptation to the perforation 21 (or 31, 41, 51) and the assembling section 22 (or 32, 42, 52) of the light guide body 20. Accordingly, the light guide substrate body 10 and the light guide body 20 are detachably assembled with each other. This is apparently different from the conventional optical component structure in use and operation form.
2. According to the (lighting) design requirement, the light source wattage, size or area, an operator can change the optical lens assembling mode and optical emission effect of the light guide substrate body 10 and the light guide body 20 or the second light guide body 30, the third light guide body 40 and the fourth light guide body 50. This can modify the light source illumination or light emission form and the arrangement form. Therefore, the problem of the conventional optical component structure is solved that it is necessary to manufacture and provide different sizes of optical lenses according to different light sources so that the manufacturing cost is increased and the variability and application degree of freedom of the cooperation between the optical lenses and the light source are lowered.

In conclusion, the knockdown optical component structure of the present invention is different from and advantageous over the conventional optical component structure in space form and effect.

The above embodiments are only used to illustrate the present invention, not intended to limit the scope thereof. Many modifications of the above embodiments can be made without departing from the spirit of the present invention.

What is claimed is:

1. A knockdown optical component structure comprising a light guide substrate body and at least one light guide body assembled therewith, the light guide substrate body and the light guide body having a geometrical form and being defined with a central reference axis, the light guide substrate body including a light guide face and an emission face corresponding to the light guide face, the light guide face being a plane face or a curved face, the light guide substrate body being formed with a circumferential section and a connection section disposed on the circumferential section, the circumferential section being positioned in a circumferential position of the light guide face and the emission face, the light guide body including a light guide face, an emission face corresponding to the light guide face and a circumferential section positioned in a circumferential position of the light guide face and the emission face, the light guide face being a plane face or a curved face, a predetermined section of the light guide body being formed with a perforation or a depression, an assembling section being disposed on the perforation or the depression, the connection section of the light guide substrate body being rotatably connected with the assembling section, whereby the light guide substrate body is detachably received in the perforation or the depression of the light guide body to form an optical component assembly.

2. The knockdown optical component structure as claimed in claim 1, wherein the light guide substrate body is a circular board body, the emission face of the light guide substrate body being a curved face or an inclined face, the height of the emission face of the light guide substrate body being progressively decreased or increased from the central reference axis to the circumferential section of the light guide substrate body, the perforation of the light guide body being formed on a central section thereof, whereby the light guide body has the form of a ring-shaped board body, the assembling section being formed on a lower section, a middle section or an upper section of the perforation, the emission face of the light guide body being a curved face or an inclined face, the height of the emission face of the light guide body being progressively decreased or increased from the central reference axis to the circumferential section of the light guide body.

3. The knockdown optical component structure as claimed in claim 1, wherein the light guide substrate body is a circular board body, the emission face of the light guide substrate body being a curved face or an inclined face, the height of the emission face of the light guide substrate body being progressively decreased or increased from the central reference axis to the circumferential section of the light guide substrate body, the depression of the light guide body being formed on a central section thereof, whereby the light guide body has the form of a ring-shaped board body, the assembling section being formed on a lower section, a middle section or an upper section of the depression, the emission face of the light guide body being a curved face or an inclined face, the height of the emission face of the light guide body being progressively decreased or increased from the central reference axis to the circumferential section of the light guide body.

4. The knockdown optical component structure as claimed in claim 2, wherein the light guide body is defined as a first light guide body, the knockdown optical component structure further comprising a second light guide body, a third light guide boy and a fourth light guide body, the circumferential section of the first light guide body being formed with a connection section, each of the second, third and fourth light guide bodies having the form of a ring-shaped board body, a perforation being formed at a central section of each of the second, third and fourth light guide bodies, an assembling section being formed on a lower section, a middle section or an upper section of the perforation, each of the second, third and fourth light guide bodies having a light guide face, an emission face corresponding to the light guide face and a circumferential section positioned in a circumferential position of the light guide face and the emission face, the circumferential sections of at least the second and third light guide bodies being respectively formed with connection sections, the connection section of the first light guide body being rotatably connected with the assembling section of the second light guide body, whereby the first light guide body is detachably received in the perforation of the second light guide body, the connection section of the second light guide body being rotatably connected with the assembling section of the third light guide body, whereby the second light guide body is detachably received in the perforation of the third light guide body, the connection section of the third light guide body being rotatably connected with the assembling section of the fourth light guide body, whereby the third light guide body is detachably received in the perforation of the fourth light guide body.

5. The knockdown optical component structure as claimed in claim 3, wherein the light guide body is defined as a first light guide body, the knockdown optical component structure further comprising a second light guide body, a third light guide boy and a fourth light guide body, the circumferential section of the first light guide body being formed with a connection section, each of the second, third and fourth light guide bodies having the form of a ring-shaped board body, a depression being formed at a central section of each of the second, third and fourth light guide bodies, an assembling section being formed on a lower section, a middle section or an upper section of the depression, each of the second, third and fourth light guide bodies having a light guide face, an emission face corresponding to the light guide face and a circumferential section positioned in a circumferential position of the light guide face and the emission face, the circumferential sections of at least the second and third light guide bodies being respectively formed with connection sections, the connection section of the first light guide body being rotatably connected with the assembling section of the second light guide body, whereby the first light guide body is detachably received in the depression of the second light guide body, the connection section of the second light guide body being rotatably connected with the assembling section of the third light guide body, whereby the second light guide body is detachably received in the depression of the third light guide body, the connection section of the third light guide body being rotatably connected with the assembling section of the fourth light guide body, whereby the third light guide body is detachably received in the depression of the fourth light guide body.

6. The knockdown optical component structure as claimed in claim 4, wherein the light guide faces of the second, third and fourth light guide bodies are plane faces or curved faces, the emission faces of the second, third and fourth light guide bodies being curved faces or inclined faces, the heights of the emission faces of the second, third and fourth light guide bodies being respectively progressively decreased or increased from the central reference axis to the circumferential sections of the second, third and fourth light guide bodies.

7. The knockdown optical component structure as claimed in claim 5, wherein the light guide faces of the second, third and fourth light guide bodies are plane faces or curved faces, the emission faces of the second, third and fourth light guide bodies being curved faces or inclined faces, the heights of the emission faces of the second, third and fourth light guide bodies being respectively progressively decreased or increased from the central reference axis to the circumferential sections of the second, third and fourth light guide bodies.

8. The knockdown optical component structure as claimed in claim 2, wherein the connection section of the light guide substrate body is selected from a group consisting of a thread, a protrusion structure and an insertion groove, while the assembling section of the light guide body is selected from a group consisting of a thread, an insertion groove and a protrusion structure, whereby the light guide substrate body is assembled in the perforation of the light guide body.

9. The knockdown optical component structure as claimed in claim 3, wherein the connection section of the light guide substrate body is selected from a group consisting of a thread, a protrusion structure and an insertion groove, while the assembling section of the light guide body is selected from a group consisting of a thread, an insertion groove and a protrusion structure, whereby the light guide substrate body is assembled in the perforation of the light guide body.

10. The knockdown optical component structure as claimed in claim 6, wherein the connection sections of the first, second, third and fourth light guide bodies are selected from a group consisting of threads, insertion grooves and protrusion structures, while the assembling sections of the first, second, third and fourth light guide bodies are selected from a group consisting of threads, insertion grooves and protrusion structures.

11. The knockdown optical component structure as claimed in claim 7, wherein the connection sections of the first, second, third and fourth light guide bodies are selected from a group consisting of threads, insertion grooves and protrusion structures, while the assembling sections of the first, second, third and fourth light guide bodies are selected from a group consisting of threads, insertion grooves and protrusion structures.

12. The knockdown optical component structure as claimed in claim 1, wherein the connection section of the light guide substrate body is a slope structure downward inclined from the circumferential section of the light guide substrate body to the central reference axis and the assembling section of the light guide body is a bearing slope structure corresponding to the connection section, the bearing slope structure being downward inclined from the perforation of the light guide body to the central reference axis, whereby the assembling section of the light guide body bears and supports the connection section of the light guide substrate body.

13. The knockdown optical component structure as claimed in claim 2, wherein the connection section of the light guide substrate body is a slope structure downward inclined from the circumferential section of the light guide substrate body to the central reference axis and the assembling section of the light guide body is a bearing slope structure corresponding to the connection section, the bearing slope structure being downward inclined from the perforation of the light guide body to the central reference axis, whereby the assembling section of the light guide body bears and supports the connection section of the light guide substrate body.

14. The knockdown optical component structure as claimed in claim 3, wherein the connection section of the light guide substrate body is a slope structure downward inclined from the circumferential section of the light guide substrate body to the central reference axis and the assembling section of the light guide body is a bearing slope structure corresponding to the connection section, the bearing slope structure being downward inclined from the perforation of the light guide body to the central reference axis, whereby the assembling section of the light guide body bears and supports the connection section of the light guide substrate body.

15. The knockdown optical component structure as claimed in claim 6, wherein the connection sections of the first, second, third and fourth light guide bodies are slope structures downward inclined from the circumferential sections of the first, second, third and fourth light guide bodies to the central reference axis and the assembling sections of the first, second, third and fourth light guide bodies are bearing slope structures corresponding to the connection sections, the bearing slope structures being downward inclined from the perforations of the first, second, third and fourth light guide bodies to the central reference axis.

16. The knockdown optical component structure as claimed in claim 7, wherein the connection sections of the first, second, third and fourth light guide bodies are slope structures downward inclined from the circumferential sections of the first, second, third and fourth light guide bodies to the central reference axis and the assembling sections of the first, second, third and fourth light guide bodies are bearing slope structures corresponding to the connection sections, the bearing slope structures being downward inclined from the perforations of the first, second, third and fourth light guide bodies to the central reference axis.

17. The knockdown optical component structure as claimed in claim 1, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

18. The knockdown optical component structure as claimed in claim 2, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

19. The knockdown optical component structure as claimed in claim 3, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

20. The knockdown optical component structure as claimed in claim 6, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.

21. The knockdown optical component structure as claimed in claim 7, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.

22. The knockdown optical component structure as claimed in claim 8, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

23. The knockdown optical component structure as claimed in claim 9, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

24. The knockdown optical component structure as claimed in claim 10, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.

25. The knockdown optical component structure as claimed in claim 11, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.

26. The knockdown optical component structure as claimed in claim 12, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.

27. The knockdown optical component structure as claimed in claim 13, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

28. The knockdown optical component structure as claimed in claim 14, wherein the assembly of the light guide substrate body and the light guide body is positioned in the light path of a light source, the light being emitted from the light source to the light guide faces of the light guide substrate body and the light guide body and then emitted from the emission faces of the light guide substrate body and the light guide body, the light beam emitted from the emission faces of the light guide substrate body and the light guide body being converged by an angle ranging from 15° to 30°.

29. The knockdown optical component structure as claimed in claim 15, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.

30. The knockdown optical component structure as claimed in claim 16, wherein the assembly of the light guide substrate body and the first, second, third and fourth light guide bodies is positioned in the light path of a light source, the light being emitted from the light source to the light guide faces of the light guide substrate body and the first, second, third and fourth light guide bodies and then emitted from the emission faces of the light guide substrate body and the first, second, third and fourth light guide bodies, the light beam emitted from the emission faces of the light guide substrate body and the first, second, third and fourth light guide bodies being converged by an angle ranging from 15° to 30°.
